(19) United States
(12) Patent Application Publication
(10) Pub. No.: US 2020/0023401 A1
(43) Pub. Date: Jan. 23, 2020

(54) DEVICE FOR COATING FOOTWEAR

(71) Applicant: Nanogate Technologies, Inc., Norwalk, CT (US)

(72) Inventor: Thomas Bryan PICKWORTH, Greenwich, OH (US)

(21) Appl. No.: 16/515,137

(22) Filed: Jul. 18, 2019

Related U.S. Application Data
(60) Provisional application No. 62/702,031, filed on Jul. 23, 2018.

(51) Int. Cl. B05B 16/40; B05C 13/02; B05B 16/60; B05B 16/80; B05B 13/02

(52) U.S. Cl. CPC B05B 16/40; B05C 13/02; B05B 13/0278; B05B 16/80; B05B 13/0242; B05B 16/60

(57) ABSTRACT

A device for coating footwear including a frame and a coating compartment engaged to the frame, wherein the coating compartment includes a cavity therein. A hingedly connected access door is engaged to the coating compartment for providing access to the cavity and closing off the cavity. A reservoir contains a coating agent and a supply line is engaged to the reservoir and facilitates the flow of coating agent from the reservoir to at least one nozzle disposed within the cavity of the coating compartment for expelling the coating agent within the cavity of the coating compartment. A turntable is positioned within the cavity of the coating compartment for placement of the footwear that is rotatable.

### CROSS REFERENCE TO RELATED PATENT APPLICATION

The present patent application/patent claims the benefit of priority of co-pending U.S. Provisional Patent Application No. 62/702,031, filed on Jul. 23, 2018, and entitled “DEVICE FOR COATING FOOTWEAR,” the contents of which are incorporated in full by reference herein.

### FIELD OF THE INVENTION

The present invention relates generally to a device for coating footwear with a coating agent and more generally relates to a device for receiving footwear on a turntable and rotating the footwear while nozzles spray the footwear with a coating agent.

### BRIEF SUMMARY OF THE INVENTION

According to an embodiment of the present invention, a device for coating footwear including a frame having a bottom portion and a top portion, the bottom portion and the top portion of the frame are engaged to each other by at least one frame leg having a first end and a second end, the first end of the frame leg is engaged to the top portion and the second end of the frame leg is engaged to the bottom portion. A coating compartment is engaged to the top portion of the frame, wherein the coating compartment comprises a base that extends outward to an outer edge, forming a cavity therein, two opposed side portions and a back portion extend upwardly from the outer edge of the base portion to an upper edge, a top portion is engaged to the upper edge of the opposed sides and the back portion, and a hingedly connected access door is engaged to the bottom portion and opposed side portions. A reservoir contains a coating agent and a supply line is engaged to the reservoir and facilitates the flow of coating agent from the reservoir at least one nozzle disposed within the cavity of the coating compartment for expelling the coating agent within the cavity of the coating compartment. A turntable is positioned within the cavity of the coating compartment for placement of the footwear that is rotatable.

According to another embodiment of the present invention, the device for coating footwear includes four nozzles disposed within the cavity of the coating compartment.

According to yet another embodiment of the present invention, the device for coating footwear includes a top portion of the coating compartment contains slots for allowing air to flow into the coating compartment.

According to yet another embodiment of the present invention, the device for coating footwear includes an access door hydraulically engaged to the coating compartment.

According to yet another embodiment of the present invention, the device for coating footwear includes the interior compartment of the coating compartment contains at least one opening and is engaged to a chamber angled inwardly to a bottom portion, the bottom portion of the chamber is engaged to a filter housing containing a filter that is engaged to a fan housing containing a fan.

According to yet another embodiment of the present invention, the device for coating footwear includes wheels engaged to the device for transporting the device.

According to yet another embodiment of the present invention, the device for coating footwear includes an overflow containment unit 52 disposed within the frame for holding the reservoir.

According to yet another embodiment of the present invention, the device for coating footwear includes a frame having a bottom portion and a top portion, the bottom portion and the top portion of the frame are engaged to each other by at least one frame leg having a first end and a second end, the first end of the frame leg is engaged to the top portion and the second end of the frame leg is engaged to the bottom portion. A coating compartment is engaged to the top portion of the frame, wherein the coating compartment comprises a base that extends outward to an outer edge, two opposed side portions and a back portion extend upwardly from the outer edge of the base portion to an upper edge, a top portion is engaged to the upper edge of the opposed sides and the back portion, and a hingedly connected access door is engaged to the bottom portion and opposed side portions. At least two wheels are engaged to bottom portion of the frame. A reservoir contains a coating agent, a supply line is engaged to the reservoir and facilitates the flow of coating agent from the reservoir at least one nozzle disposed within the cavity of the coating compartment for expelling the coating agent within the cavity of the coating compartment. An overflow containment unit 52 is positioned within the frame for holding the reservoir, and a turntable is positioned within the cavity of the coating compartment for placement of the footwear that is rotatable.

According to yet another embodiment of the present invention, the device for coating footwear includes a frame having a bottom portion and a top portion, the bottom portion and the top portion of the frame are engaged to each other by at least one frame leg having a first end and a second end, the first end of the frame leg is engaged to the top portion and the second end of the frame leg is engaged to the bottom portion. A coating compartment is engaged to the top portion of the frame, wherein the coating compartment comprises a base that extends outward to an outer edge, two opposed side portions and a back portion extend upwardly from the outer edge of the base portion to an upper edge, a top portion is engaged to the upper edge of the opposed sides and the back portion, and a hingedly connected access door is engaged to the bottom portion and opposed side portions. At least two wheels are engaged to bottom portion of the frame. A reservoir contains a coating agent, a supply line is engaged to the reservoir and facilitates the flow of coating agent from the reservoir at least one nozzle disposed within the cavity of the coating compartment for expelling the coating agent within the cavity of the coating compartment. An overflow containment unit 52 is positioned within the frame for holding the reservoir, and a turntable positioned within the cavity of the coating compartment for placement of the footwear that is rotatable. At least one opening within the top portion of the coating compartment allowing air to flow into the coating compartment.

### BRIEF DESCRIPTION OF THE DRAWINGS

The present invention is illustrated and described herein with reference to the various drawings, in which like reference numbers denote like method steps and/or system components, respectively, and in which:

FIG. 1 is a front perspective of the present invention with some of the panels removed;

FIG. 2 is a side cut-away view of the present invention;

FIG. 3 is a top perspective view of some of the internal components of the present invention;

FIG. 4 is another top perspective view of some of the internal components of the present invention;

FIG. 5 is a bottom perspective view of the present invention with some of the panels removed;

FIG. 6 is a partial exploded view of the present invention;

FIG. 7 is a perspective view of the present invention;

FIG. 8 is a perspective view of the present invention;

FIG. 9 is a perspective view of the present invention;

FIG. 10 is a perspective view of internal components of the present invention;

FIG. 11 is another perspective view of the internal components of the present invention; and

FIG. 12 is a side view of the internal components of the present invention.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

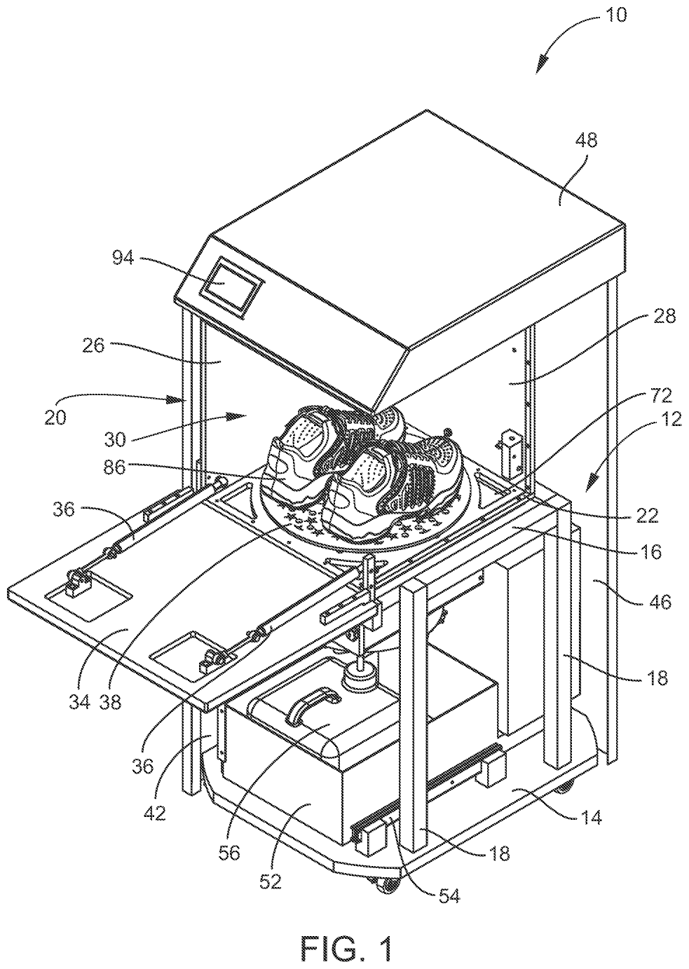

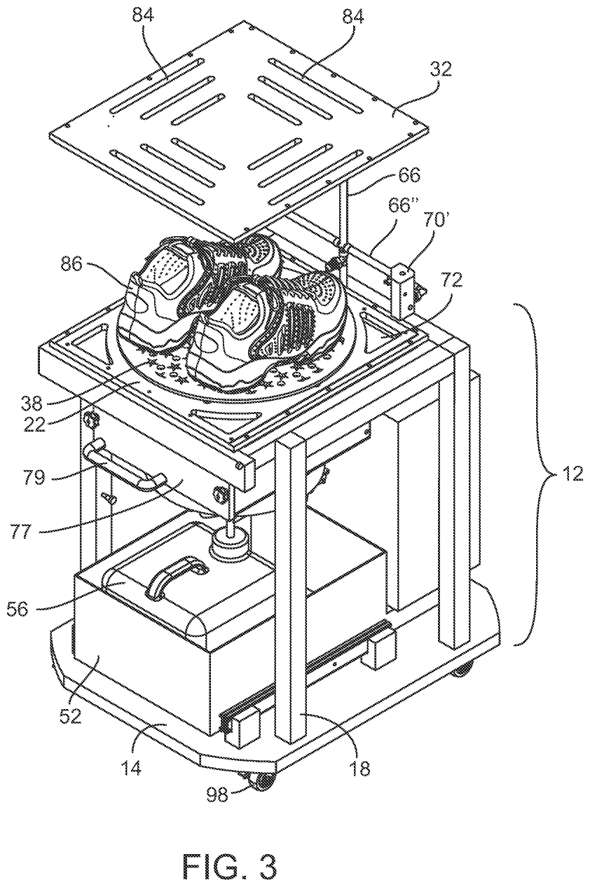

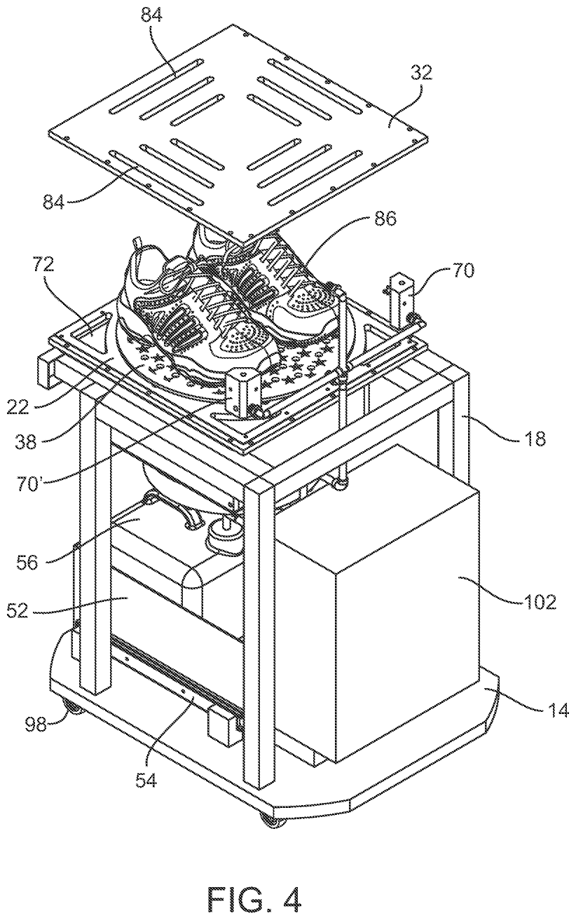

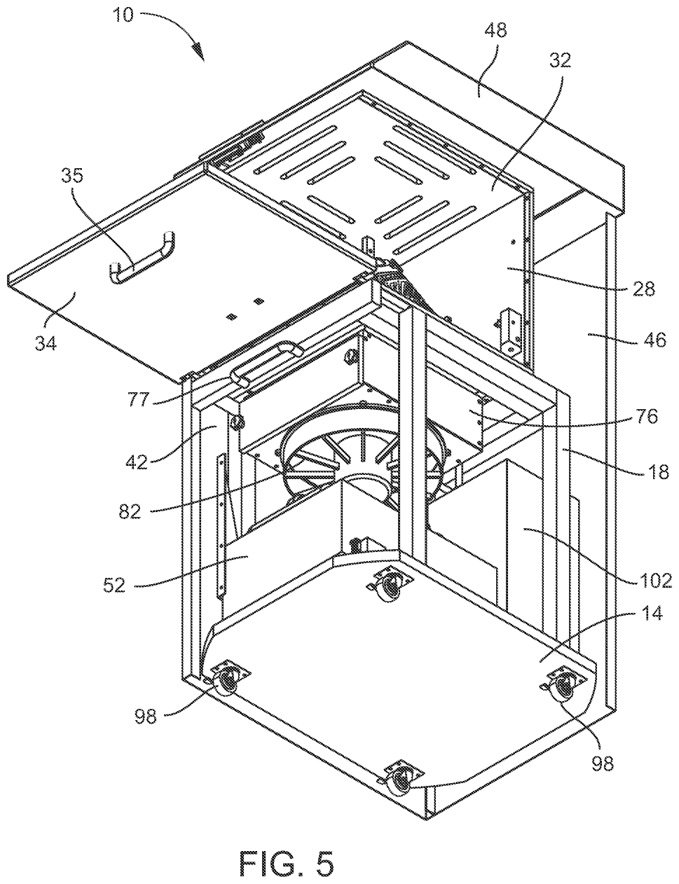

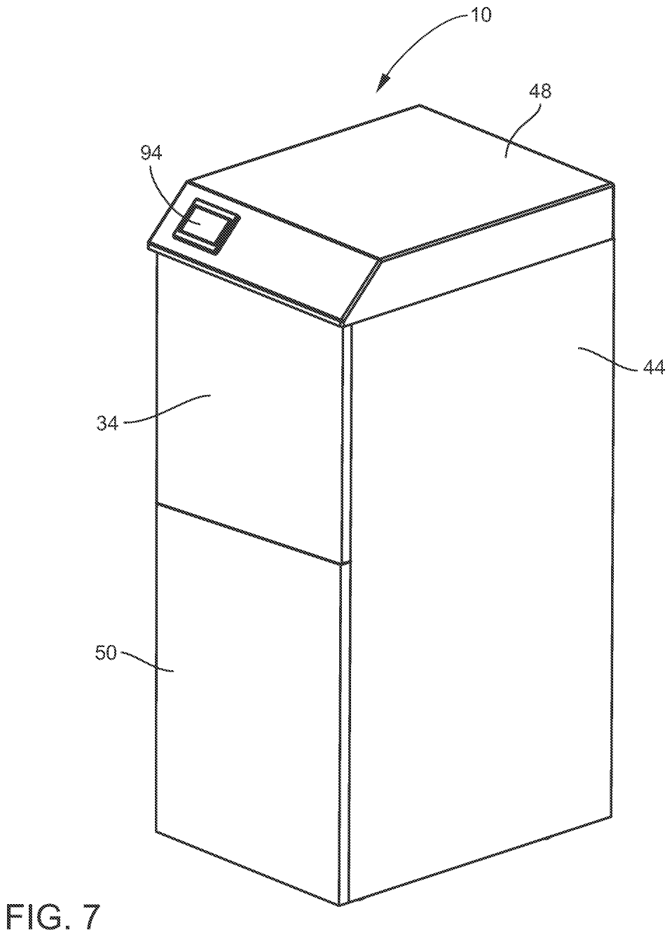

Referring now specifically to the drawings, a device for coating footwear 86 is illustrated in FIGS. 1-12 and is shown generally at reference numeral 10. The device 10 contains a frame 12 having a bottom portion 14 and a top portion 16. The bottom portion 14 and the top portion 16 of the frame 12 are engaged to each other by frame legs 18 having a first end and a second end, which provide support and stability for the top portion 16 of the frame 12. The first end of the frame legs 18 are engaged to the top portion 16 of the frame 12, and the bottom portion 14 of the frame legs 18 are engaged to the bottom portion 14 of the frame 12. As illustrated in FIGS. 4-9, the frame 12 consists of four frame legs 18 and having a rectangular or square cross-section. However, any cross-section and number of frame legs 18 may be used. For example, the frame 12 may consist of one fame leg 18, two frame legs 18, three frame legs 18, or a plurality of frame legs 18. Wheels 98 or castors may be engaged to the bottom portion 14 for transporting the device 10, as shown in FIG. 5.

A coating compartment 20 is engaged to the top surface of the top portion 16 of the frame 12. The coating compartment 20 consists of a base portion 22 that extends outward to an outer edge 24. Two opposed side portions 26 and a back portion 28 extend upwardly from the outer edge 24 of the base portion 22 to an upper edge forming a cavity 30 therein. The top portion 32 is engaged to the upper edge of the two opposed side portions 26 and the back portion 28. A hingedly connected access door 34 is engaged to the bottom portion 14 and/or two opposed side portions 26. The access door 34 provides access to the cavity 30 formed within the base portion, opposed side portions 26, back portion, and top portion. Two hydraulic arms 36, having a first end and a second end, are engaged to the access door 34 and opposed side portions 26. Although, two hydraulic arms 36 are illustrated, the device 10 may use one hydraulic arm 36 or a plurality of hydraulic arms 36. The first end of each hydraulic arm is engaged to the back side of the access door 34 and the second end of each hydraulic arm is engaged to the interior side of the side portion 26.

As illustrated in FIGS. 1, 2, 3, 4, 10, and 11, a turntable 38 may be disposed within the interior compartment of the coating compartment 20. The turntable 38 is adjacent the top side of the base portion 22 and engaged and rotated by a central axis point 100 engaged to a central location of the bottom side of the turntable 38. Spring loaded rollers 40 are disposed on the top side of the base portion 22 of the coating compartment 20 and contact the bottom side of the turntable 38. The spring loaded rollers 40 provide support and stability to the turntable 38 and allow for smoother and more efficient rotation of the turntable 38 within the coating compartment 20. The central axis point 100 is engaged to a motor 96, such as a gear motor, for rotating the central axis point 100 and in turn the turntable 38. The central axis point 100 preferably has a first end engaged to the bottom side of the turntable 38 and extends downwardly from the turntable 38. A second end of the central axis point 100 is coupled to the motor 96 that rotates the central axis point 100 and rotates the turntable 38. Alternatively, the central axis point 100 may be a location on the bottom side of the turntable 38 that is engaged to a portion of the motor 96, such as a rotating shaft, that causes the turntable 38 to rotate.

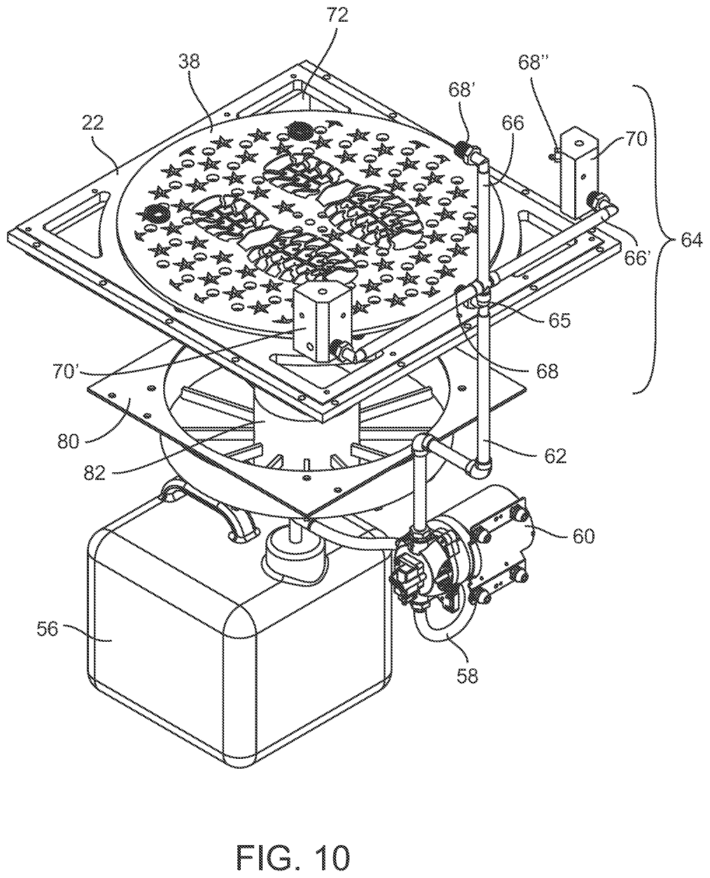

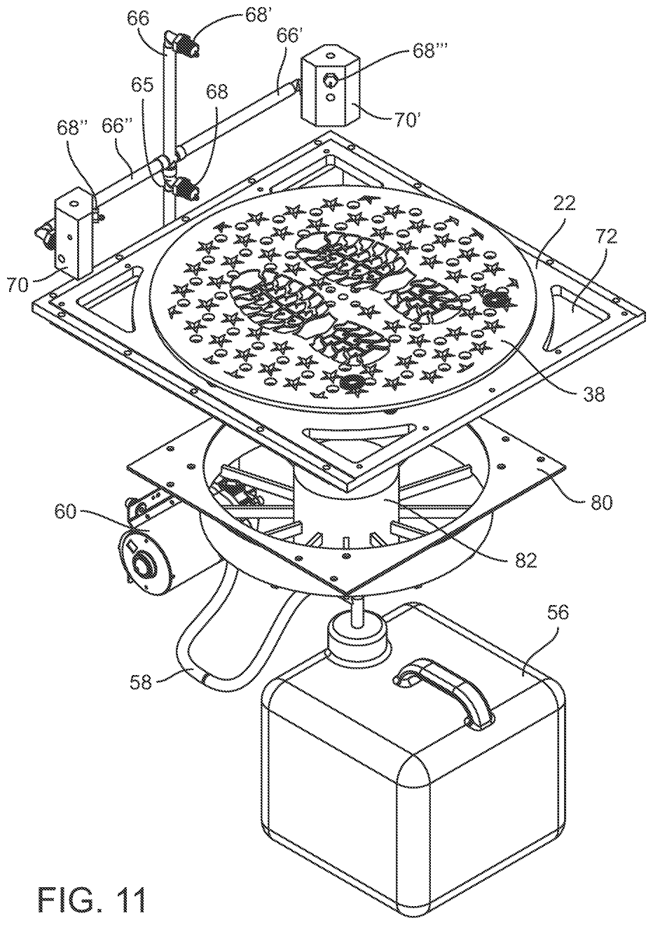

As shown in FIGS. 10-11, the top side of the turntable 38 may consist of an aesthetically pleasing pattern. Additionally, the design of footwear soles or shoe soles are imprinted on the top side of the turntable 38 indicating to the user the proper location to place footwear 86 on the turntable 38.

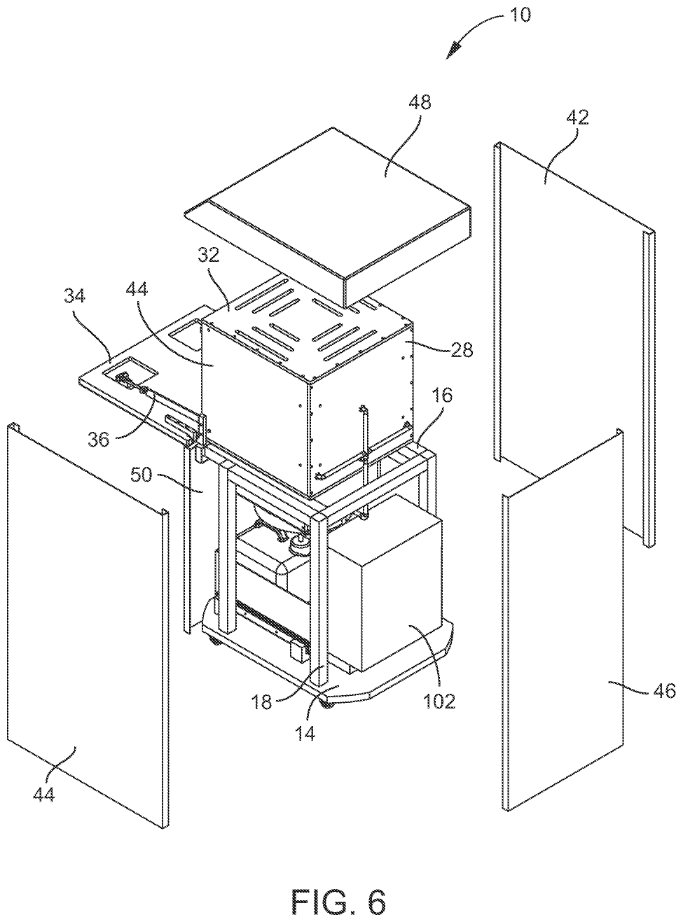

An outer shell may be placed around the frame 12 and coating compartment 20 to increase the aesthetic appeal of the device 10 and protect the internal components of the device 10. As illustrated in FIG. 6, the outer shell consists of a first side panel 42 and a second side panel 44 engaged to either side of the device 10. A back panel 46 is engaged to the back portion 28 of the device 10. A top panel 48 is disposed over the top portion 32 of the coating compartment 20 allowing for an inner spatial portion between the top portion 32 of the coating department 20 and top panel 48 for allowing air to flow into the cavity 30 of the coating compartment 20 and out of the coating compartment 20. A front panel 50 is engaged to the frame 12 and below the access door 34.

A reservoir 56 may be disposed within the bottom portion 14 of the frame 12, and specifically positioned on the top side of the base portion 22 of the frame 12. An optional overflow containment unit 52 is slidably engaged to the top side of the base portion 22 of the frame 12. The overflow containment unit 52 essentially is box shaped, meaning it has a base that extends outwards to an outer edge and two pairs of opposed side portions extending upwardly from the base forming a cavity therein. The overflow containment unit 52 is engaged to a pair of extension slides 54 allowing the overflow containment unit 52 having a first position and a second position. In the first position, the overflow containment unit 52 is fully positioned above the base portion 22 of the frame 12, allowing the front panel 50 to be engaged to the frame 12. In the second position, the extension slides 54 are extended, allowing the overflow containment unit 52 to extend outwardly from the base portion 22 and requiring the removal of the front panel 50 from the frame 12 to access the overflow containment unit 52.

The reservoir 56 may be positioned within the cavity 30 of the overflow containment unit 52. The reservoir 56 stores the coating agent that is sprayed on the footwear 86 in the coating compartment 20. The reservoir 56 contains an opening and the inlet of a first supply line 58 is positioned within the opening of the reservoir 56 so the coating agent may be drawn into the inlet of the first supply line 58. The outlet of the first supply line 58 is engaged to a pump 60. The pump 60 is positioned between the first supply line 58 and a second supply line 62. The pump 60 draws the coating agent from the reservoir 56 and into the inlet of the first supply line 58. The coating agent proceeds along the length of the first supply line 58 and out of the outlet of the first supply line 58 and into the pump 60. The coating agent exits the pump 60 and into the inlet of the second supply line 62. The coating agent proceeds along the length of the second supply line 62. The outlet of the second supply line 62 is engaged to a nozzle assembly 64. In an alternative embodiment, the pump 60 may be placed adjacent or engaged to the reservoir 56 for pumping the coating agent from the reservoir 56 and into the inlet of the first supply line 58. In this arrangement, the outlet of the first supply line 58 may be engaged to a nozzle 68 or a nozzle assembly 64. In another alternative embodiment, a reservoir 56 engaged, disposed, or positioned within the frame 12 or the device 10 is not needed. Instead, the coating agent may be stored in a reservoir or other containment vessel and separate or spaced-apart from the device 10. This reservoir or containment vessel is coupled to the inlet of the first supply line 58, or alternatively a pump engaged to the first supply line 58 for introducing the coating agent into the first supply line 58.

The nozzle assembly 64 consists of at least one nozzle 68 disposed such that it can spray the coating agent within the cavity 30 of the coating compartment 20. The nozzle assembly 64 can also include an engagement portion 65 disposed on the first end of the nozzle assembly 64, which is a connection point for connecting the nozzle assembly 64 to the outlet of the second supply line 62. As illustrated, the first end of the engagement portion 65 has a diameter smaller than the diameter of the outlet of the second supply line 62, and the first end of the engagement portion 65 fits within the outlet of the second supply line 62. The first end of the engagement portion 65 may be retained in the outlet of the second supply line 62 by friction fit, a fastening device that is secured around the external side of the second supply line 62 for retaining the first end of the engagement portion 65 within the outlet of the second supply line 62, or alternatively, the first end of the engagement portion 65 may be externally threaded and the interior surface of the outlet of the second supply line 62 may contain corresponding internal threads for forming a selectively secured arrangement. Selectively secured means the first end of the engagement portion 65 may be removed from the outlet of the second supply line 62 and is not integral, but remains engaged until a users desires to separate the first end of the engagement device 65 from the outlet of the second supply line 62. In another embodiment, the first end of the engagement portion 65 may be integral with the outlet of the second supply line 62 or an extension of the second supply line 62.

The nozzle assembly 64 may contain branch lines 66, 66′, and 66″ that carry the coating agent from the engagement portion 65 to a nozzle 68, 68′, 68″, and 68′″. As shown in FIG. 10, the nozzle assembly 64 contains three branch lines 66, 66′, and 66″ and four nozzles 68, 68′, 68″, and 68″. A centrally located first nozzle 68 is disposed on the engagement portion 65 and adjacent the intersection of the outlet of the second supply line 62 and the first end of the nozzle assembly 64. The engagement portion 65 is located in close proximity to the base portion 22 of the coating compartment 20. A first branch line 66 extends upwards from the engagement portion 65 of the nozzle assembly 64 and towards the top portion 32 of the coating compartment 20. The inlet of the first branch line 66 is engaged to an outlet of the engagement device 65, preferably the outlet is positioned on the second end of the engagement device 65 and the inlet of the first branch line 66 is engaged thereto for allowing the coating agent to flow from the engagement portion 65 and into the inlet of the first branch line 66.

A second nozzle 68′ is engaged to the top portion of the branch line 66 and may extend at about a 90° angle from the top portion of the first branch line 66 and through a bore within the back portion 28 of the coating compartment 20. As shown in FIG. 6, the branch assembly 64 is positioned adjacent the exterior side of the back portion 28 of the coating compartment 20 and the nozzles 68, 68′, 68″, and 68′″ and/or branch lines 66, 66″, and 66″ may extend through the back portion 28 of the coating compartment 20 from the exterior side to the interior side for spraying the coating agent within the cavity 30 of the coating compartment 20. A second branch line 66″ and a third branch line 66′″ extend outwards from each side of the engagement portion 65 and preferably in a horizontal direction. In other words, the second branch line 66′ extends horizontally from a side of the engagement portion 65 and a third branch line 66″ extends horizontally on the right side of the engagement portion 65. The inlets of the second branch line 66′ and the third branch line 66″ are engaged to outlets positioned on each side of the engagement portion 65 for allowing coating agent to flow from the outlets on each side of the engagement portion 65 and into the inlet of the second branch line 66′ and the third branch line 66″.

A first securement device 70 may be engaged to the outlet of the second branch line 66′. A second securement device 70′ may be engaged to the outlet of the third branch line 66″. The first and second securement devices 70 and 70′ have a generally triangularly shaped back side that contains a first side and a second side. The first side of the back side of the first and second securement devices 70 and 70′ are engaged to the interior side of an opposed side portion 26 of the coating compartment 20. The second side of the back side of the first and second securement devices 70 and 70′ are engaged to the interior side of the back portion 28 of the coating compartment 20. The first and second securement devices 70 and 70′ may have an internal channel, wherein the outlet of the second and third branch lines 66′ and 66″ may be engaged to an inlet in the first and second securement devices 70 and 70′. The coating agent proceeds from the outlet of the second and third branch lines 66′ and 66″ and into the channel. The coating agent proceeds along the channel and exits the outlet of the first securement device 70, wherein a third nozzle 68″ is positioned. Likewise, a fourth nozzle 68′″ is positioned on the second securement device 70′ for spraying the coating agent the proceeds along the channel of the second securement device 70′. Preferably, the third and fourth nozzles 68″ and 68′″ are directed at a 45° degree angle with respect to the back portion 28 of the coating compartment 20. In other words, the third and fourth nozzle 68″ and 68′″ are positioned at a 45° angle formed between the third and fourth nozzle 68″ and 68′″ and the back portion 28 of the coating compartment 20. The nozzle assembly 64 may contain only one nozzle 68, two or more nozzles 68, or a plurality of nozzles 68. As illustrated, the first and second securement devices 70 and 70′ do not touch the intersection of the opposed side portions 26 and the back portion 28 of the coating compartment 20, forming corners of the coating compartment 20. This spacing between the back side of the first and second securement devices 70 and 70′ and the corners formed by the intersection of the opposed side portions 26 and back portion 28 allow air and coating agent to flow freely and prevents build-up of coating agent within the corners and on the first and second securement devices 70 and 70′.

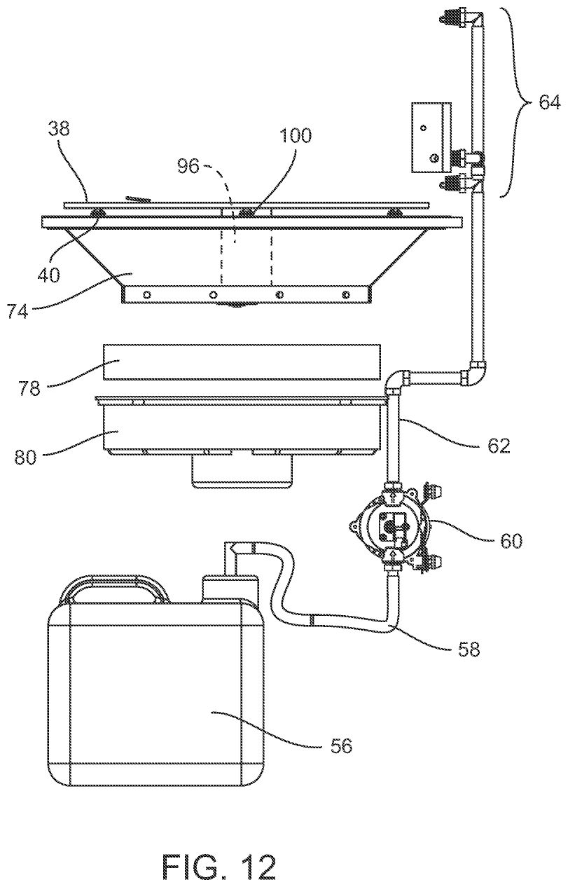

The base portion 22 of the frame 12 contains at least one opening 72, as shown in FIGS. 10 and 11. As illustrated, the base portion 22 contains four openings 72 adjacent the corners of the base portion 22. The openings 72 are generally triangularly shaped for allowing the widest openings when the turntable 38 is circular. A chamber 74 is disposed below the base portion 22 and positioned within the top portion of the frame 12, as illustrated in FIG. 12. The chamber 74 is concave shape, meaning the diameter of the upper portion of the chamber 74 is larger than the diameter of the lower portion of the chamber 74. In other words, the chamber 74 is angled downward from its upper portion to its lower portion. The lower portion of the chamber 74 is engaged to a filter housing 76. The filter housing 76 contains at least one filter 78 therein. The filter housing 76 contains a cavity therein for retaining the filter 78 within the filter housing 76. As illustrated, the filter housing 76 has a bottom portion that extends to an outer edge. Two opposed side portions and a back portion extend upwards from the outer edge to an upper edge and a top portion engaged to the upper edge, wherein the cavity of the filter housing 76 is formed within the bottom portion, two opposed side portions, and back portion. A front panel 77 is positioned on the front of the filter housing 76 and adjacent an edge of the bottom portion, two opposed side portions, back portion, and top portion. The front panel 77 has a handle 79 engaged to the exterior side for allowing a user to access the cavity and filter 78 contained therein. The front panel may be hingedly connected to the bottom portion for allowing access to the cavity for removing and inserting a filter 78 or filters.

The filter 78 is preferably composed of activated carbon treated with potassium permanganate. The filter housing 76 may contain one or more filters 78. If more than one filter 78 is disposed within the filter housing 76, a step-filtering process may be employed, wherein the first filter 78 the air contacts removes a specific range of sizes of particles the subsequent filters remove particles of different sizes. Additionally, a screen or other layer with bores may cover the filter for preventing larger particulate matter and/or debris from entering or contacting the filter 78. The bottom portion of the filter housing 76 is engaged to a fan housing 80 containing a fan 82. The fan 82 may be a 1711 CFM fan that draws air through the chamber 74 and into the filter housing 76 and through the filter 78 contained therein.

During operation, the nozzles 68 spray the coating agent within the cavity 30 of the coating compartment 20. Afterwards, it is desired to remove the coating agent from the air within the cavity 30 of the coating compartment 20. Therefore, the fan 82 is activated and pulls the air containing the coating agent through the chamber 74 and into the filter housing 76 where the coating agent is filtered by the filters. A vacuum is not created within the coating compartment 20 because the top portion 32 of the coating compartment 20 contains openings 44 in the form of slots, disposed on the top portion 32 of the coating compartment 20 and extending from the exterior side to the interior side of the coating compartment 20, allowing air to flow into and out of the coating compartment 20.

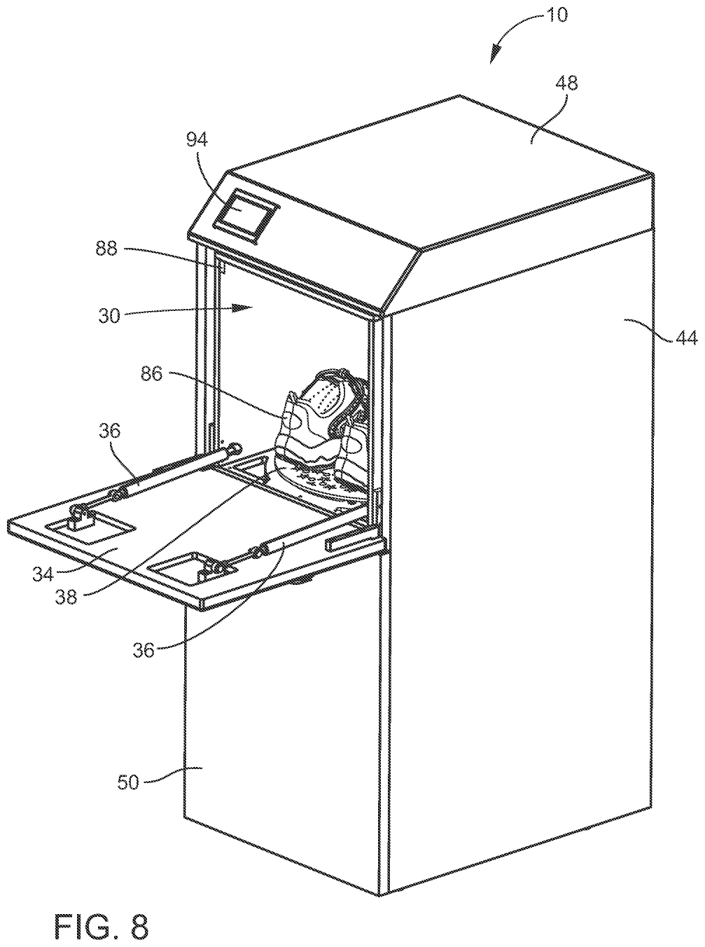

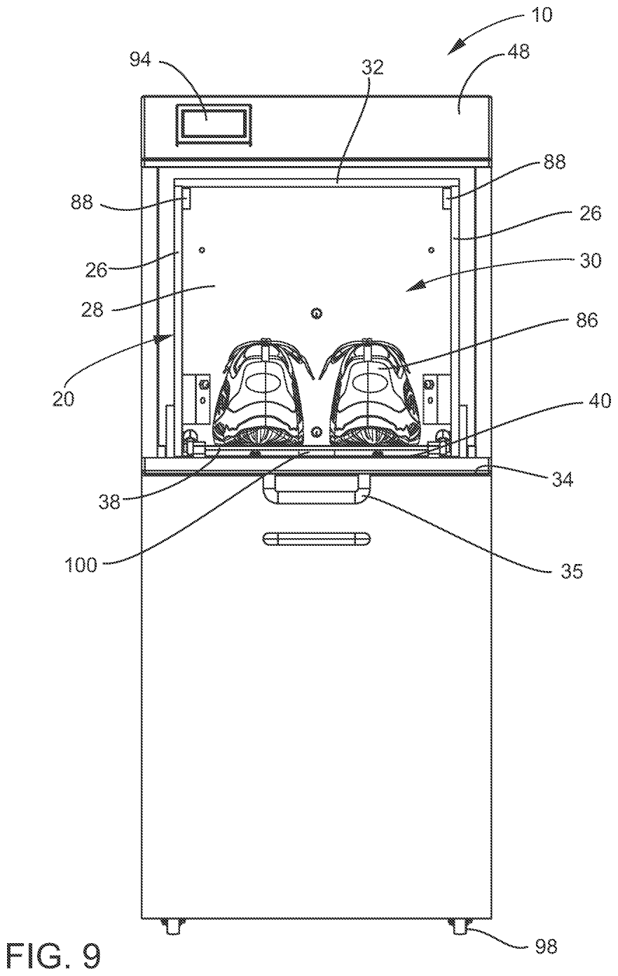

The device 10 may also contain a magnetic door locking system for keeping the access door 34 closed during operation of the device 10. Alternatively, the force of the hydraulic arms 38 may keep the access door 34 shut until a force greater than that of the hydraulic arms 38 pulls on the access door 34 and gains access to the cavity 30 of the coating compartment 20. When the footwear 86 is inserted into the coating compartment 20 and the device 10 is activated to begin the coating cycle, the device 10 activates magnets 88, as shown in FIGS. 8 and 9 that may be contained within the cavity 30 and engaged to opposed side portions 26 and/or top portion 32, of the magnetic door locking system locking the access door 34. Preferably the access door 34 is metal, so the magnets 88 are selectively secured to the access door 34. Alternatively, the back side of the access door 34 that faces the cavity 30 contains a corresponding magnet 88. Once the cycle is completed and the air within the cavity 30 of the coating compartment 20 is filtered, the magnets 88 are deactivated by the device 10, allowing the access door 34 to be opened. The front side of the access door 34 may contain a handle 35 for allowing a user to easily open the access door 34.

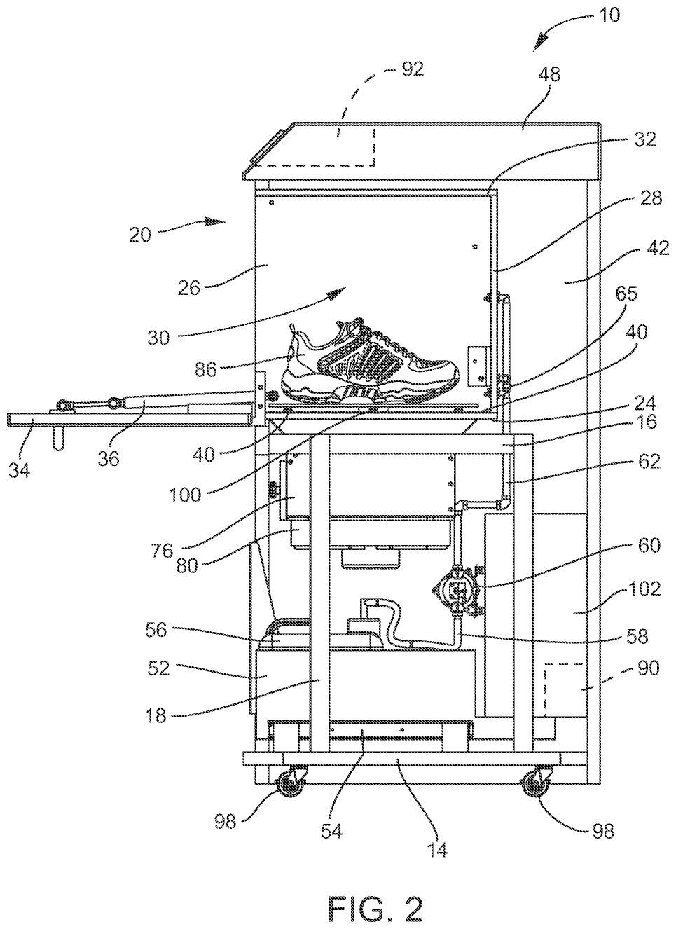

As shown in FIG. 2, a programmable logic controller (PLC) 90 is positioned within the frame 12 and accessible through the back panel 46. The PLC 90 is contained within the back compartment 102 with one side positioned on the bottom portion 14 of the frame 12 and the other side of the back compartment 102 extends upward from to bottom portion 14 towards the top portion 16 of the frame 12. The PLC 90 is communicatively coupled to a human machine interface (HMI) 92. Preferably, the HMI 92 is positioned on the top portion of the coating compartment 20 and visible and accessible through a window 94 within the top panel 48. The HMI 92 allows the user to select a cycle for applying a coating agent to the footwear 86. The device 10 has four different cycles depending upon the composition of the footwear 86 to be treated. For example, the device 10 has a different cycle for sued, synthetic leather, leather, and textiles. An emergency stop may be activated during any cycle to stop the application of the coating agent by the nozzles 68.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A device for coating footwear, comprising:
a frame;
a coating compartment engaged to the frame, wherein the coating compartment comprises a cavity disposed within the interior of the coating compartment;
an access door for providing access to the cavity of the coating compartment;
a reservoir containing a coating agent for coating the footwear;
a supply line engaged to the reservoir facilitating the flow of coating agent from the reservoir;
at least one nozzle disposed within the cavity of the coating compartment for expelling the coating agent within the cavity of the coating compartment.

2. The device for coating footwear according to claim 1, further comprising two or more nozzles disposed within the cavity of the coating compartment.

3. The device for coating footwear according to claim 1, wherein the top portion of the coating compartment contains slots for allowing air to flow into the coating compartment.

4. The device for coating footwear according to claim 1, wherein the access door is hydraulically engaged to the coating compartment.

5. The device for coating footwear according to claim 1, further comprising a turntable that is rotatable and positioned within the cavity of the coating compartment.

6. The device for coating footwear according to claim 1, wherein the device includes wheels for transporting the device.

7. The device for coating footwear according to claim 1, further comprising an overflow containment unit disposed within the frame for holding the reservoir.

8. A device for coating footwear, comprising:
a frame having a bottom portion and a top portion, the bottom portion and the top portion of the frame are engaged to each other by at least one frame leg having a first end and a second end, the first end of the frame leg is engaged to the top portion and the second end of the frame leg is engaged to the bottom portion;
a coating compartment is engaged to the top portion of the frame, wherein the coating compartment comprises a base that extends outward to an outer edge, two opposed side portions and a back portion extend upwardly from the outer edge of the base portion to an upper edge, forming a cavity therein, a top portion is engaged to the upper edge of the opposed sides and the back portion, and a hingedly connected access door is engaged to the bottom portion and opposed side portions;
at least one nozzle disposed within the cavity of the coating compartment for expelling coating agent within the cavity of the coating compartment;
a supply line having an inlet and an outlet, the inlet of the supply line receives the coating agent that progresses along the length of the supply line and the coating agent exits the supply line at the outlet for the at least one nozzle to expel within the cavity of the coating compartment; and
a turntable positioned within the cavity of the coating compartment for placement of the footwear that is rotatable.

9. The device for coating footwear according to claim 8, further comprising four nozzles disposed within the cavity of the coating compartment.

10. The device for coating footwear according to claim 8, wherein the top portion of the coating compartment contains openings for allowing air to flow into the coating compartment.

11. The device for coating footwear according to claim 8, wherein the access door is hydraulically engaged to the coating compartment.

12. The device for coating footwear according to claim 8, wherein the interior compartment of the coating compartment contains at least one opening and engaged to a chamber angled inwardly to a bottom portion, the bottom portion of the chamber is engaged to a filter housing containing a filter that is engaged to a fan housing containing a fan.

13. The device for coating footwear according to claim 8, wherein the device includes wheels for transporting the device.

14. The device for coating footwear according to claim 8, further comprising a reservoir position within the device for storing the coating agent.

15. A device for coating footwear, comprising:
a frame having a bottom portion and a top portion, the bottom portion and the top portion of the frame are engaged to each other by at least one frame leg having a first end and a second end, the first end of the frame leg is engaged to the top portion and the second end of the frame leg is engaged to the bottom portion;
a coating compartment is engaged to the top portion of the frame, wherein the coating compartment comprises a base that extends outward to an outer edge, two opposed side portions and a back portion extend upwardly from the outer edge of the base portion to an upper edge, forming a cavity therein, a top portion is engaged to the upper edge of the opposed sides and the back portion, and a hingedly connected access door is engaged to the bottom portion and opposed side portions;
a reservoir containing a coating agent;
a supply line engaged to the reservoir facilitating the flow of coating agent from the reservoir;
at least one nozzle disposed within the cavity of the coating compartment for expelling the coating agent within the cavity of the coating compartment;
an overflow containment unit positioned within the frame for holding the reservoir; and
a turntable positioned within the cavity of the coating compartment for placement of the footwear that is rotatable.

16. The device for coating footwear according to claim 15, further comprising two or more nozzles disposed within the cavity of the coating compartment.

17. The device for coating footwear according to claim 15, wherein the access door is hydraulically engaged to the coating compartment.

18. The device for coating footwear according to claim 15, wherein the interior compartment of the coating compartment contains at least one opening and is engaged to a chamber angled inwardly to a bottom portion, the bottom portion of the chamber is engaged to a filter housing containing a filter that is engaged to a fan housing containing a fan.

19. The device for coating footwear according to claim 15, wherein the device includes wheels for transporting the device.

20. The device for coating footwear according to claim 15, further comprising a program logic controller communicatively coupled to a human machine interface for controlling the operation of the device.
